(19) United States
(12) Patent Application Publication
(10) Pub. No.: US 2020/0130832 A1
(43) Pub. Date: Apr. 30, 2020

(54) DISCHARGE VALVE ASSEMBLY FOR A COLLAPSIBLE, AERIAL FIRE-FIGHTING BUCKET

(71) Applicant: AERIAL FIRE CONTROL INTERNATIONAL PTY LTD, Hahndorf (AU)

(72) Inventor: Christopher Herbert BLACK, Hahndorf (AU)

(21) Appl. No.: 16/670,160

(22) Filed: Oct. 31, 2019

(30) Foreign Application Priority Data
Oct. 31, 2018 (AU) 2018904127

(51) Int. Cl. B64D 1/16; A62C 3/02; B67D 3/02

(52) U.S. Cl. CPC B64D 1/16; B67D 3/02; A62C 3/0235

(57) ABSTRACT

A discharge valve assembly for opening and closing the discharge opening of a collapsible, aerial fire-fighting bucket, the discharge valve assembly including an upper member and a lower member, wherein:
a) the upper member is a disc-shaped closure with a peripheral seal-receiving channel and an annular seal seated in the channel; and
b) the lower member is a bucket mounting assembly with a mounting frame and a central shaft, the mounting frame including a central hub and radially extending legs for mounting the central hub to the discharge opening of the bucket, the central shaft extending upwardly from the central hub;
   and wherein the upper member is mounted on the central shaft of the lower member for movement along the central shaft from a closed position, where the annular seal is in sealing engagement with a sealing rim of the discharge opening, to an open position allowing filling and emptying of the fire-fighting bucket through the discharge opening.

### TECHNICAL FIELD

The present invention relates to discharge valves for use with collapsible, aerial fire-fighting buckets of the type suspended below an aircraft. Typically, such an aircraft would be a helicopter.

### BACKGROUND OF INVENTION

Large fires or fires in remote locations are often fought using aircraft to drop chemical fire retardants or water either directly on the fire or at nearby locations to create a fire break. Helicopters are often used for such operations because they do not require a dedicated landing strip and more importantly because they can fill their fire-fighting bucket without the need to land the helicopter. Typically, the bucket can be filled at a nearby body of water which may include a lake, dam, river or even a swimming pool. Having the ability to fill the bucket in this way reduces the time between water drops, hopefully resulting in the fire being extinguished more quickly. Filling the bucket locally also saves fuel and other running costs which can be extremely expensive.

U.S. Pat. No. 5,829,809 describes a bucket for use with an aircraft which permits dumping of two or more separate loads of water for a single fill of the bucket. The apparatus has an outer bucket with an outer dump valve and an inner bucket with an inner dump valve. The inner bucket is located within the outer bucket and a space is established therebetween to provide a clearance to receive water. The dump valves are flexible sleeves which are operable independently of each other and in sequence so that the outer dump valve is opened before the inner dump valve. As evident from the Figures of U.S. Pat. No. 5,829,809, the illustrated apparatus includes significant rigging and lines to control the operation of the valves. Such rigging and lines may be easily fouled resulting in the inability to release water from the bucket and in an extreme situation this may result in the decision to jettison the bucket. Buckets according to U.S. Pat. No. 5,829,809 also have a tendency to leak due to the inner dump valve not sealing correctly, the purse strings are very prone to wear and tend to have a poor drop pattern due to the inner dump valve flailing in the wind when the water is jettisoned.

U.S. Pat. No. 6,192,990 describes a fire-fighting bucket including a valve for controllably releasing a stream of fluid over a fire. Its valve releases water from the bucket when the solid side wall of the valve is raised vertically away from a base plate. The valve is controlled by a complicated control head suspended above the bucket. Further, the valve is very large and thus takes up a lot of space inside the bucket reducing the bucket's water carrying capacity and limiting the nature of the rim assemblies usable to maintain open the upper opening of the bucket. The valve seals are also very difficult to replace and the bucket is very heavy. Accordingly, the bucket is very difficult to transport, store and load into an aircraft.

The applicant's earlier Australian patent 2005225146 identified various problems associated with different fire-fighting buckets and also the valves used in such buckets. That patent further described a valve used to control the release of water from a fire-fighting bucket. The valve is located within a valve body and is operated by a linear screw motor that can be controlled to close sealing plates against respective ports. The valve body is quite large and its ports are located above the base of the bucket. Accordingly, even if the walls of the bucket are capable of collapse, the size and configuration of the valve, which is not collapsible, makes transport and storage of the bucket problematic. Also, the need for this valve to properly align four different sealing areas (the three ports and the lower main opening) requires a higher level of manufacturing precision, and regular maintenance, which would ideally be avoided.

The present invention seeks to provide an improved discharge valve assembly for a collapsible, aerial fire-fighting bucket.

Before turning to a summary of the present invention, it is to be appreciated that various directional terms, such as upper, lower, upwardly, vertical, bottom and the like, have been used throughout this specification to provide context and clarity for the invention with reference to its normal upright use when a fire-fighting bucket is slung below a helicopter with its discharge opening lowermost for the purpose of allowing to liquid to flow therefrom downwardly under the force of gravity. These terms are not to be taken as limiting the invention to be used only in one particular orientation.

The discussion of the background to the invention herein is included to explain the context of the invention. This is not to be taken as an admission that any of the material referred to was published, known or part of the common general knowledge as at the priority date of this application.

### SUMMARY OF INVENTION

The present invention provides a discharge valve assembly for opening and closing the discharge opening of a collapsible, aerial fire-fighting bucket, the discharge valve assembly including an upper member and a lower member, wherein:
a) the upper member is a disc-shaped closure with a peripheral seal-receiving channel and an annular seal seated in the channel; and
b) the lower member is a bucket mounting assembly with a mounting frame and a central shaft, the mounting frame including a central hub and radially extending legs for mounting the central hub to the discharge opening of the bucket, the central shaft extending upwardly from the central hub;
   and wherein the upper member is mounted on the central shaft of the lower member for movement along the central shaft from a closed position, where the annular seal is in sealing engagement with a sealing rim of the discharge opening, to an open position allowing filling and emptying of the fire-fighting bucket through the discharge opening.

The upper member of the discharge valve assembly is a disc-shaped closure with a peripheral seal-receiving channel and an annular seal seated in the channel. The relatively low profile provided for the upper member by its flat and circular (and ideally thin) shape is advantageous in that the upper member then does not extend very far upwardly into the interior of the bucket, either when in the closed or open positions. The discharge valve assembly then is less likely to interfere with the sidewalls of the bucket when collapsed, with any strings or cables used to support and hang the bucket, or with any support framing used about the upper opening of the bucket.

In a preferred form, the upper surface of the upper member is reasonably free of extraneous connections and structures, again so as to render the upper surface less likely to catch on, or interfere with, other aspects of the bucket and its operation. Having said that, in one form of the present invention the upper surface may have incorporated therewith an actuator capable of interacting with the central shaft of the lower member to provide the required movement of the upper member to and from its open and closed positions. It is envisaged that such an actuator will be located centrally of the upper member and will ideally be a linear actuator having a bi-directional motor capable of providing a reversible linear motion to the central shaft of the lower member.

The lower member of the discharge valve assembly is a bucket mounting assembly with a mounting frame and a central shaft, the mounting frame including a central hub and radially extending legs for mounting the central hub to the discharge opening of the bucket, with the central shaft extending upwardly from the central hub. In a preferred form, the mounting frame includes three legs extending radially from the central hub, so as to form a tripod. In one form, the free end of each of the three legs includes a mounting flange configured to engage with a sealing rim that is formed as a part of the discharge opening of the bucket. The legs of the tripod may then be secured to the sealing rim to thereby rigidly secure the tripod (and thus the lower member of the discharge valve assembly) to the bucket. As a result, the upwardly extending central shaft extends into the interior of the bucket upwardly through the discharge opening.

As mentioned above, the upper member is then mounted on the upwardly extending central shaft for bi-directional movement along the central shaft from a downwards, closed position, where the annular seal is in sealing engagement with the discharge opening, to an upwards, open position allowing filling and emptying of the fire-fighting bucket through the discharge opening.

The actuator and the central shaft may in some forms be protected from lateral impacts or damage by the adoption of one or more vertical guide posts positioned thereabout that extend upwardly from the tripod, adjacent to the side wall of the actuator, in one form passing inside hollow tubes attached to the side wall of the actuator for added strength. These guide posts assist in preventing rotation of the valve assembly and also assist in preventing a lateral impact from damaging the central shaft and the actuator.

The upper member includes a seal-receiving channel about its periphery, with the channel being configured so as to be able to receive and seat an annular seal therein, such as a toroidal seal that would often be referred to as a gasket or an O-ring. Typically, such toroidal seals will be continuous loops of elastomer with a circular cross-section, which seat in a groove for compression against another part during operation (in the case of a valve), creating a seal at the interface of the gasket or O-ring with the other part. For the purposes of the following discussion, the size of such annular seals will be referenced herein with respect to both a diameter and a width, the width being the maximum thickness of the seal's (usually circular) cross-section and the diameter being the outside diameter of the seal itself.

In the present invention, the peripheral channel of the upper member, in cross-section, preferably opens outwardly, away from the centre of the upper member, in a manner such that a substantial portion of the annular seal remains outwardly exposed when seated in the channel, providing a relatively large area that can become the interface of the seal with the other part during sealing. In this form, the other part is envisaged to be the sealing rim mentioned above, formed as a part of the discharge opening of the bucket.

The sealing rim of the discharge opening is preferably inclined inwardly and downwardly, preferably with at least an upper portion that is convexly curved. In this form, as the upper member is moved to its closed position, the outwardly exposed portion of the annular seal is able to contact and compress against the upper portion of the sealing rim at any longitudinal position therealong, without the need for precision in positioning, to thereby form a seal between the upper member and the sealing rim.

In this respect, this positioning flexibility during sealing is aided by utilising a seal with a relatively large width, at least with respect to the curvature and depth of the preferred form of sealing rim on the discharge opening. This of course then requires the peripheral channel of the upper member to be correspondingly sized, and thus also to have a relatively large width, so as to satisfactorily receive and seat the seal.

In relation to the preferred form of sealing rim, being an inclined sealing rim with at least an upper portion that is convexly curved, the sealing rim serves as a collar for the discharge opening, ideally with the upper portion mentioned above together with a lower vertical portion (again with reference to the normal upright use of the fire-fighting bucket). In this form, it is the lower vertical portion, which is preferably a generally straight portion, to which the radially extending legs of the mounting frame (and ideally the mounting flanges of the tripod in the preferred form) may be secured to rigidly mount the lower member to the discharge opening and thus to the bucket.

The annular seal may be made of any type of suitable material, preferably an elastic material to allow expansion of the seal to permit removal of it from the channel for maintenance or repair, and for ease of manufacture. It is envisaged that any elastomer will be suitable, including both saturated and unsaturated rubbers, and thermoplastic elastomers.

However, some consideration does need to be given to the density of such materials. The typical use of fire-fighting buckets does see them needing to be sunk into bodies of water, for the purposes of re-filling, reasonably quickly. Operationally, substantial difficulties can be encountered, which can at the very least put the lives of aircraft crew at risk, if a fire-fighting bucket does not sink and fill in acceptable timeframes. Typically, most fire-fighting buckets rely on lead weights/ballast blocks fixed onto one side of the top rim of the bucket to roll the bucket over as it hits a water source, the aim being to fill the bucket faster. However, the addition of such lead weights creates a hazard to a helicopter and its pilot, in that the pilot must then chase the top of the bucket as it rolls over, to keep the helicopter centred over the top of it, which can put a helicopter tail rotor very close to the water. With the present invention, a bucket utilising the inventive discharge valve assembly is ideally able to remain vertical throughout an entire filling process, making for safer operation and a clear visual reference for the pilot of how full the bucket is.

The sink rate of any fire-fighting bucket is critical not only to reducing the cycle times from the water source to the fire, but also to enable multiple helicopters to fill up quickly from a single water source, without causing a backlog of helicopters lined up on the same water source. Generally, a period of between 10 and 15 seconds is acceptable for re-filling any volume of bucket. For example, a typical 400-litre prior art bucket might take between 10 and 12 seconds to fill. However, the applicant has found that with a bucket utilising the discharge valve assembly of the present invention, the fill time is reduced to being between 5 and 6 seconds.

In this respect, care must thus be taken to use a seal (such as an elastomeric seal) in the discharge valve assembly that does not introduce unwanted buoyancy to a fire-fighting bucket that otherwise is known to sink at acceptable rates, thus slowing down the time it takes for a bucket using the inventive discharge valve assembly to sink in a body of water. While it is of course useful to continue to lower the profile of a discharge valve assembly, and to continue to make such assemblies less complex and lighter, a threshold will be encountered where the overall weight at the bottom of the bucket will then not be sufficient, particularly taking into account the normal shape of collapsible fire-fighting buckets. While weights can of course be added to such buckets, it is more efficient (and preferred) to ensure the discharge assembly itself provides sufficient weight to the overall arrangement.

In the present invention, it is preferred to use an elastomeric material for the annular seal of the upper member, but then to provide a suitable balance between the weight of such an elastomeric annular seal and the typically reduced weight of the upper and lower members due to their reduced profile and their simplicity. Also to be considered within this balance is the resilience of a particular elastomeric material and its ability to provide an adequate seal under the pressure of the weight of liquid being transported in the bucket.

In one form, this balance can be provided by using a hollow toroidal elastomeric seal, such as a hollow rubber O-ring (in a basic form simply being an inflatable tyre tube, such as the type used for motor vehicles), and to liquid fill the seal with a suitably dense liquid. For example, it has been found that a hollow toroidal elastomeric seal filled with salt water or demineralised water, with or without an additional liquid such as a vegetable glycerine, and void of air, at a suitable pressure or volume can provide the right balance. In this form, salt water preferably includes at least about 25% salt w/w and more preferably includes at least about 30% salt w/w, while a combination of about 70% w/w vegetable glycerine with about 30% w/w demineralised water has also proven successful. In this respect, it will be appreciated that vegetable glycerine (or vegetable glycerin) is also known simply as glycerol or glycerine and is a clear liquid typically made from soybean, coconut or palm oils.

It will thus be appreciated that the discharge valve assembly of the present invention provides a simple and low profile sealing arrangement for opening and closing the discharge opening of a collapsible aerial fire-fighting bucket. The discharge valve assembly provides just a single, low profile closure (the upper member), requires the bucket to have just a single discharge opening, and provides a single seal that does not require precision alignment during sealing and that can be easy to replace and maintain.

### BRIEF DESCRIPTION OF DRAWINGS

Having briefly described the general concepts involved with the present invention, a preferred embodiment of a discharge valve assembly will now be described that is in accordance with the present invention. However, it is to be understood that the following description is not to limit the generality of the above description.

In the drawings:

FIG. 1 is a perspective view from above of a collapsible, aerial fire-fighting bucket for use with a discharge valve assembly (not shown) in accordance with the present invention, with the bucket body expanded; and

FIG. 2 is a side view similar to FIG. 1, but with the bottom part of the bucket body broken away to show a discharge valve assembly in accordance with a preferred embodiment of the present invention;

FIG. 3 is a disassembled perspective view from above of the discharge valve assembly of FIG. 2;

FIGS. 4 and 5 are perspective views from above of the discharge valve assembly of FIG. 2, relative to a sealing rim, in the open position (FIG. 4) and the closed position (FIG. 5), additionally showing the optional use of automated flapper ports; and

FIGS. 6 and 7 are respective side sectional views of the discharge assembly of FIGS. 4 and 5 when in situ with a fire-fighting bucket.

### DETAILED DESCRIPTION OF PREFERRED EMBODIMENT

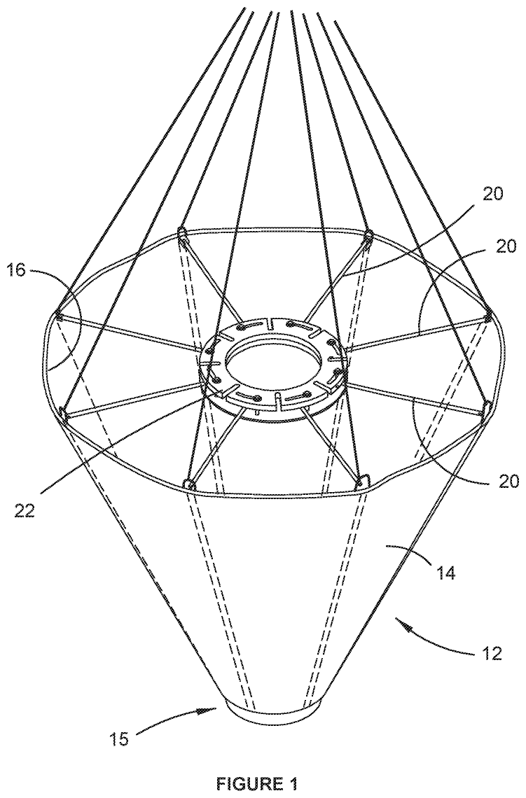

Illustrated in FIG. 1 is an aerial fire-fighting bucket 12, the bucket 12 including a collapsible body 14 having a lower discharge end 15, and an upper rim 16 surrounding an open upper end of the body 14. The upper end of the body 14 is shown with a preferred form of hub and spoke assembly that includes a plurality of spokes 20 about a central hub 22. The spokes 20 extend radially outwardly from the hub 22, with each outer end of a spoke 20 being pivotably connected to the upper rim 16 of the body 14, and each inner end of a spoke 20 being pivotably connected to the hub 22. In FIG. 1 the spokes 20 are deployed, the central hub 22 is in its uppermost position, and the bucket body 14 is expanded and ready for use. It will be appreciated that the when the spokes 20 are folded down, and the central hub 22 is in its lowermost position, then the bucket body 14 will be collapsed.

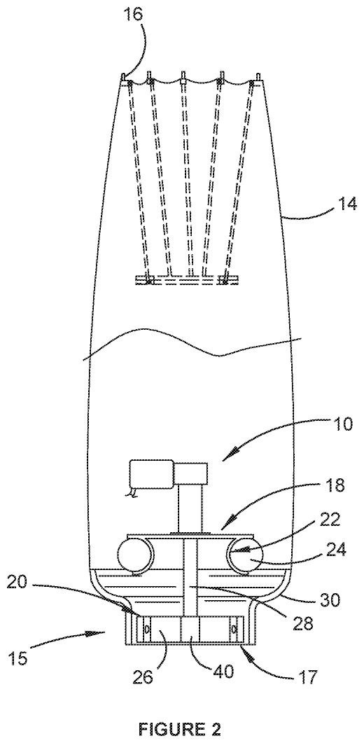

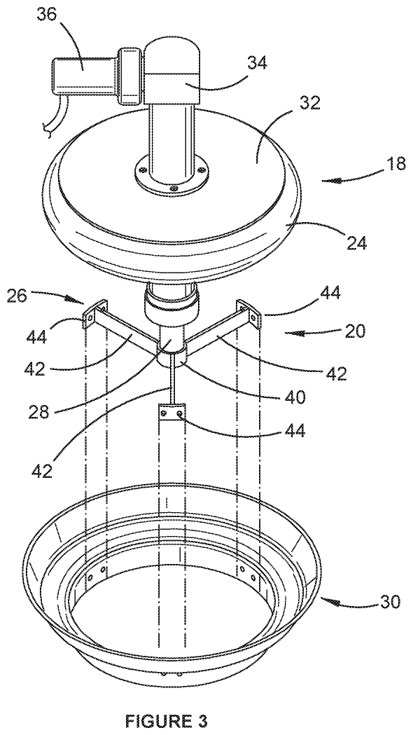

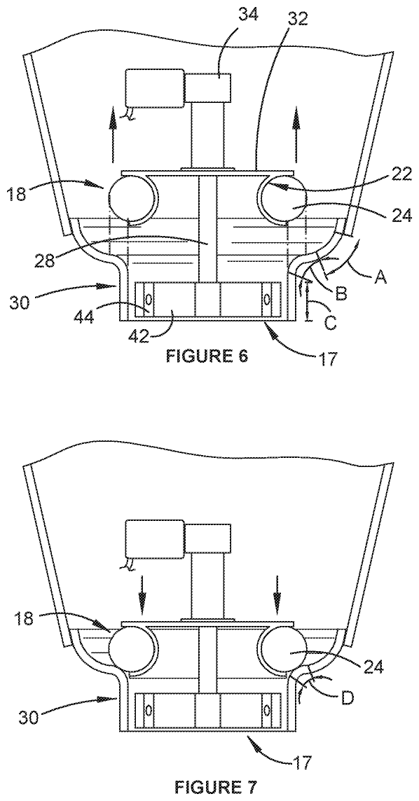

Illustrated in FIG. 2 is a general view of a discharge valve assembly 10 in accordance with this preferred embodiment of the present invention, for opening and closing the discharge opening 17 at the discharge end 15 of the bucket 12. More detail of the discharge valve assembly 10 will be described below with reference to the perspective views of FIGS. 3, 4 and 5 and the side sectional views of FIGS. 6 and 7.

Nonetheless, still evident in FIG. 2 are the upper member 18 and the lower member 20 of the assembly 10, with the upper member 18 being a disc-shaped closure with a peripheral seal-receiving channel 22 and an annular seal 24 seated in the channel 22. Also, evident in FIG. 2 is the lower member 20 being in the form of a bucket mounting assembly with a mounting frame 26 and a central shaft 28, wherein the upper member 18 is mounted on the central shaft 28 for movement along the central shaft 28 from a closed position (see FIG. 6), where the annular seal 24 is in sealing engagement with a sealing rim 30 of the discharge opening 17, to an open position (see FIG. 5) allowing filling and emptying of the fire-fighting bucket 12 through the discharge opening 17.

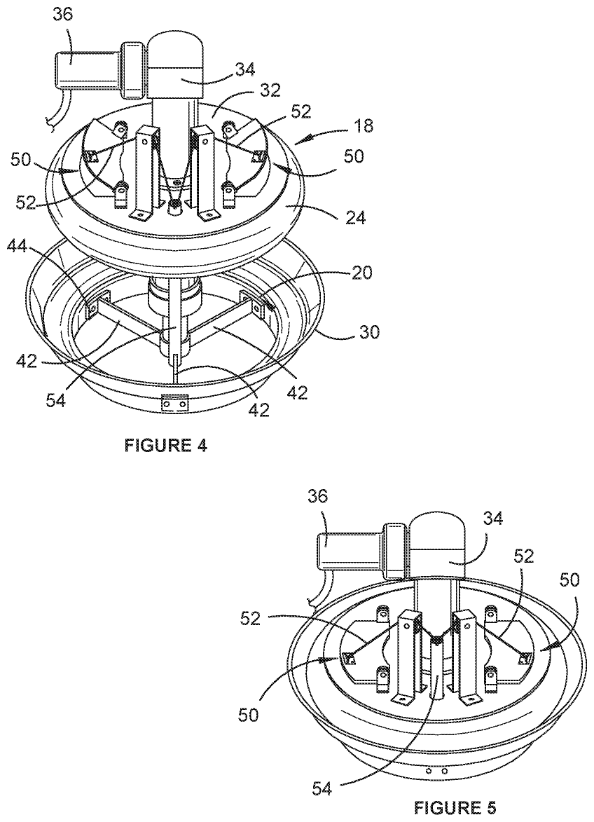

Referring now to FIGS. 3, 4 and 5, the upper member 18 of the discharge valve assembly 10 is a disc-shaped closure with a peripheral seal-receiving channel 22 and an annular seal 24 seated in the channel 22. As mentioned above, the relatively low profile provided for the upper member 18 by its flat and circular (and ideally thin) shape is advantageous in that the upper member 18 then does not extend very far upwardly into the interior of the bucket 12, either when in the closed or open positions of FIGS. 4 and 5.

In this preferred embodiment, the upper surface 32 of the upper member 18 is free of extraneous connections and structures, with the exception of an actuator 34 capable of interacting with the central shaft 28 of the lower member 20 to provide the required movement of the upper member 18 to and from its open and closed positions. The actuator 34 is located centrally of the upper member 18 and is a linear actuator having a bi-directional motor 36 capable of providing a reversible linear motion to the central shaft 28 of the lower member 20.

Having said that, it should be appreciated that the upper surface 32 of the upper member 18 may in some embodiments include additional minor connections, such as hydraulic or pneumatic connections for the annular seal or the actuator.

Additionally, it may be useful to include one or more one-way check valves, referred to in the art as flapper ports, that permit flow of water from the discharge opening up through the upper member 18 and into the bucket when the bucket is filling, but not back therethrough when the discharge opening is sealed and the bucket is full of water. For the sake of drawing simplicity, an example of this has been illustrated only in the views of FIGS. 4 and 5, where automated flapper ports 50 are shown that are mechanically linked to the movement of the upper member 18, such as by attaching cables 52 via a fixed connecting riser 54 between a flapper port 50 and the lower member 20. The fixed connecting riser 54 is sealed to move up and down relative to the upper member 18 with the movement up and down of the lower member 20. This acts to raise the flapper ports 50 from their closed position (FIG. 5) to their open position (FIG. 4) as the upper member 18 is raised to open the discharge opening 17. This action permits more rapid discharge of the water in the bucket 12 (ie, through both the discharge opening 17 and the open flapper ports 50) when the upper member 18 is raised to open the discharge opening 17, and also more rapid filling of the bucket 12 given that the flapper ports 50 are held open during the filling.

In this respect, the proximity of the sidewall of the bag 14 to the annular seal 24 may decrease the fill time if flapper ports 50 are not utilised, noting that when the bucket 12 is being filled it is purely the weight of the bucket 12 and the liquid contained within the annular seal 24 that submerges the bucket 12. Obviously a pilot cannot force a bucket into a water supply. The provision of such automated flapper ports 50 can thus be useful if the filling time of the bucket 12 needs to be reduced further.

Another advantage of utilising flapper ports 50 is that the upper member 18 does not have to rise excessively high to achieve the maximum inflow of water relative to the diameter of the discharge opening 17. The configuration of the preferred embodiment allows the upper member 18 to be raised approximately 125 mm from fully closed to fully open.

The lower member 20 of the discharge valve assembly 10 is a bucket mounting assembly with a mounting frame 26 and a central shaft 28, the mounting frame 26 including a central hub 40 and radially extending legs 42 for mounting the central hub 40 to the discharge opening 17 of the bucket 12, with the central shaft 28 extending upwardly from the central hub 40. In this embodiment, the mounting frame 26 includes three legs 42 extending radially from the central hub to form a tripod.

The free end of each of the three legs 42 includes a mounting flange 44 configured to engage with a sealing rim 30 (best shown in FIGS. 4 and 5, and also FIGS. 6 and 7) that is formed as a part of the discharge opening 17 of the bucket 12. The legs 42 of the tripod are shown in FIG. 4 secured to the sealing rim 30 to thereby rigidly secure the tripod (and thus the lower member 20 of the discharge valve assembly 10) to the bucket 12. As a result, the upwardly extending central shaft 28 extends into the interior of the bucket 12 upwardly through the discharge opening 17.

The upper member 18 is mounted on the upwardly extending central shaft 28 for bi-directional movement along the central shaft 28 from a downwards, closed position (FIGS. 5 and 7), where the annular seal 24 is in sealing engagement with the sealing rim 30 of the discharge opening 17, to an upwards, open position (FIGS. 2, 4 and 6) allowing filling and emptying of the fire-fighting bucket 12 through the discharge opening 17.

The upper member 18 includes a seal-receiving channel 22 (best shown in FIGS. 6 and 7) about its periphery, with the channel 22 being configured to receive and seat the annular seal 24 therein. The annular seal 24 seats in the channel 22 for compression against the sealing rim 30 during operation, creating a seal at the interface of the annular seal 24 with the sealing rim 30. In this embodiment, the channel 22, in cross-section, opens outwardly, away from the central shaft 28, such that a substantial portion of the annular seal 24 remains outwardly exposed when seated in the channel 22, providing a relatively large area that can become the interface of the seal 24 with the sealing rim 30.

In FIGS. 6 and 7, the sealing rim 30 of the discharge opening 17 is inclined inwardly and downwardly, from an upper concave portion A, through an upper convex portion B, to a lower vertical portion C. In this embodiment, as the upper member 18 is moved from its open position (FIG. 6) to its closed position (FIG. 7), the outwardly exposed portion of the annular seal 24 is able to contact and compress against the upper convex portion B of the sealing rim 30 at any longitudinal position ID (FIG. 7) therealong, without the need for precision in positioning, to thereby form a seal between the upper member 18 and the sealing rim 30.

In this respect, this positioning flexibility during sealing is aided by utilising a seal 24 with a relatively large width, at least with respect to the curvature and depth of the preferred form of sealing rim 30 at the discharge opening 17. The peripheral channel 22 of the upper member is correspondingly sized, and has a relatively large width to satisfactorily receive and seat the seal 24.

By way of example, and to put aspects of the discharge valve assembly in context, collapsible fire-fighting buckets that have capacities of 400 to 1,500 litres generally have single discharge openings and thus need a single valve assembly, while buckets that have capacities of 1,600 to 20,000 litres tend to require multiple discharge openings and hence include multiple valve assemblies set equidistantly about a base plate (such base plates being up to 3 metres in diameter). It is envisaged that the smaller, single discharge opening buckets will have a single discharge opening with a diameter of approximately 400 mm, whilst the multi-valve buckets might have three, four, six and up to ten or 12 similarly sized discharge openings in the base.

Sizes such as these will thus dictate the use of annular seals with diameters in the range of 400 to 450 mm, and as will be outlined below in more detail, the use of sealing rims ideally having depths in the range of 90 to 150 mm, such that the preferred width of a seal seated in a peripheral channel might be in the order of 70 to 100 mm.

In this embodiment, the annular seal 24 is a hollow toroidal elastomeric seal, such as a hollow rubber O-ring (that can quite simply be an inflatable tyre tube, such as the type used for motor cars or motor cycles, preferably of a heavy duty design), liquid filled with a suitably dense liquid. For example, it has been found that a tyre tube filled with salt water to a suitable pressure or volume is acceptable, the salt water preferably includes at least about 10% salt w/w and more preferably includes at least about 25% salt w/w. However, where the presence of the salt water might be regarded as being too corrosive, then it has also been found that a mixture of a vegetable glycerine with distilled water (70/30 by weight) is suitable.

In relation to this suitably dense liquid, sink rate tests were conducted by the applicant on a water filled sealed plastic vessel. Incremental increases of the dense liquid to fresh water ratio were initiated, with the vessel attached to a line with depth markers on it to record the submersion depth after each addition of salt.

The vessel floated on the surface while only containing fresh water, with no air held inside the vessel. Salt was gradually added to the water in the vessel in 10-gram increments and dissolved by hand mixing, whereupon a weight ratio of 10 to 15% of salt to fresh water was reached. At this ratio the vessel descended to a full depth of 2.4 metres.

To ensure that the level of salt added to the annular seal 24 described above in relation to the Figures was adequate, allowance was made for a margin of error on the mix ratio of salt to fresh water. Indeed, some maintenance of buckets of this type is carried out in the field, typically with no access to measuring scales. With this in mind, it is expected that a level of salt to water (by volume) needs to be at least 25% and up to 38%, 38% being the maximum saturation point of salt in fresh water. In this respect, it will be appreciated that any value over 38% will result in un-dissolved salt being retained in the annular seal.

Adding salt or a vegetable glycerine to fresh or distilled water increases the density and thus the specific gravity of the liquid, enabling a bucket with the inventive discharge valve assembly to sink rapidly in either fresh water or in the ocean. Helicopters will on occasion source water from the ocean, which has around 3.5% salinity or 35 parts per thousand (1 litre of sea water contains 35 grams of salt). With the discharge valve assembly of the preferred embodiment described above, and with the use of the denser liquid referred to, the applicant has allowed for a bucket to be filled in the ocean, with no decrease in the fill/sink rate.

The applicant also looked at using other heavier than water fluids but found them to be either very expensive, such as maple syrup, not environmentally friendly, such as dish soap, or not viscous enough, such as honey, to enable easy use, so these fluids for some uses will be less ideal. For example, these fluids might be less desirable in situations where the fluid is to be pumped into the annular seal, by in this case a simple low pressure hand pump, such as used for spraying chemicals for garden maintenance (due to viscosity issues), or where the buckets or valves might be stored in sub-zero temperatures outside during winter, where again heavily salted water would be an ideal choice. International shipment of the buckets was also considered in the choice of salt water and vegetable glycerine over more complex fluids, with there being few freighting restrictions on such materials, and with salt and vegetable glycerine being readily available in countries where fire-fighting is conducted.

In conclusion, it must be appreciated that there may be other variations and modifications to the configurations described herein which are also within the scope of the present invention.

1. A discharge valve assembly for opening and closing the discharge opening of a collapsible, aerial fire-fighting bucket, the discharge valve assembly including an upper member and a lower member, wherein:
a) the upper member is a disc-shaped closure with a peripheral seal-receiving channel and an annular seal seated in the channel; and
b) the lower member is a bucket mounting assembly with a mounting frame and a central shaft, the mounting frame including a central hub and radially extending legs for mounting the central hub to the discharge opening of the bucket, the central shaft extending upwardly from the central hub;
and wherein the upper member is mounted on the central shaft of the lower member for movement along the central shaft from a closed position, where the annular seal is in sealing engagement with a sealing rim of the discharge opening, to an open position allowing filling and emptying of the fire-fighting bucket through the discharge opening.

2. A discharge valve assembly according to claim 1, wherein the peripheral channel in cross-section is outwardly open such that a substantial portion of the annular seal remains outwardly exposed when seated in the channel.

3. A discharge valve assembly according to claim 1, wherein the sealing rim is inclined inwardly and downwardly, with at least an upper portion that is convexly curved, such that as the upper member is moved to its closed position, the outwardly exposed portion of the annular seal is able to contact and compress against the upper portion of the sealing rim at any longitudinal position therealong to thereby form a seal between the upper member and the sealing rim.

4. A discharge valve assembly according to claim 1, wherein the sealing rim includes a lower vertical portion to which the radially extending legs of the mounting frame may be secured to rigidly mount the lower member to the discharge opening and thus to the bucket.

5. A discharge valve assembly according to claim 1, wherein the annular seal is formed of an elastic material, including elastomers selected from the list of saturated and unsaturated rubbers, and thermoplastic elastomers.

6. A discharge valve assembly according to claim 1, wherein the annular seal is a toroidal seal.

7. A discharge valve assembly according to claim 1, wherein the annular seal is a hollow toroidal seal filled with a liquid.

8. A discharge valve assembly according to claim 7, wherein the liquid is salt water or a mixture of vegetable glycerine and distilled water.

9. A discharge valve assembly according to claim 8, wherein the salt water includes at least about 10% salt w/w, and more preferably includes at least about 25% salt w/w, or wherein the mixture of vegetable glycerine and distilled water is 70/30 by weight.

10. A discharge valve assembly according to claim 1, wherein the upper member includes an upper surface having incorporated therewith an actuator capable of interacting with the central shaft of the lower member to provide movement of the upper member to and from its open and closed positions.

11. A discharge valve assembly according to claim 10, wherein the actuator is located centrally of the upper member and is a linear actuator having a bi-directional motor capable of providing a reversible linear motion to the central shaft of the lower member.

12. A discharge valve assembly according to claim 1, wherein the mounting frame includes three legs extending radially from the central hub, so as to form a tripod.

13. A discharge valve according to claim 12, wherein the free end of each of the three legs includes a mounting flange configured to engage with the sealing rim to thereby rigidly secure the tripod to the bucket.

14. A discharge valve according to claim 1, wherein the upper member includes one or more flapper ports that permit flow of water from the discharge opening up through the upper member and into the bucket when the bucket is filling, but not back therethrough when the discharge opening is sealed and the bucket is full.

15. A discharge valve according to claim 14, wherein the flapper ports are automated flapper by being mechanically linked to the movement of the upper member, so as to raise the flapper port from its closed position to its open position as the upper member is raised to open the discharge opening.

16. A discharge valve according to claim 15, wherein the mechanical link is a cable attached between a flapper port and the lower member.
